(19) United States
(12) Patent Application Publication
(10) Pub. No.: US 2023/0190006 A1
(43) Pub. Date: Jun. 22, 2023

(54) INTELLIGENT MOVABLE AND RETRACTABLE BED FRAME

(71) Applicant: JIAXING SINO HARDWARE MANUFACTURING CO.,LTD, Jiaxing (CN)

(72) Inventors: Klaus Bellingroth, Jiaxing (CN); Junwei Qian, Jiaxing (CN); Peng Liu, Jiaxing (CN)

(73) Assignee: JIAXING SINO HARDWARE MANUFACTURING CO.,LTD, Jiaxing (CN)

(21) Appl. No.: 18/113,088

(22) Filed: Feb. 23, 2023

(30) Foreign Application Priority Data
Nov. 11, 2022 (CN) 202223014652.X

(51) Int. Cl. A47C 19/12; A61G 7/018

(52) U.S. Cl. CPC A47C 19/122; A61G 7/018

(57) ABSTRACT

The present disclosure discloses an intelligent movable and retractable bed frame, including an upper bed frame and a bottom bed frame; the upper bed frame is hinged with the bottom bed frame; the upper bed frame includes an upper frame rod and an upper frame crossarm with one end connected to the upper frame rod; the upper frame crossarm is connected with an upper frame extending stand which can transversely move along the upper frame crossarm; the bottom bed frame includes a bottom frame rod and a bottom frame crossarm with one end connected to the bottom frame rod; the bottom frame crossarm is connected with a bottom frame extending stand which can transversely move along the bottom frame crossarm; and the upper frame extending stand is hinged with the bottom frame extending stand.

### TECHNICAL FIELD

The present disclosure relates to the technical field of intelligent homes, more specifically to an intelligent movable and retractable bed frame.

### BACKGROUND

The prior art relates to a hand-operated medical hospital bed that is easy to fold, retract and unfold, and includes a bed frame composed of a leg board bed frame and a backboard bed frame; two ends of the bed frame respectively support a bedside frame; bed frame inner end faces on both sides of the two bed frames are spliced with each other; the bed frame inner end faces at the spliced positions form a pair of friction support surfaces; a pair of hinge plates is arranged on the two bed frames below each pair of friction support surfaces; a leg board and a back board are hinged with the bed frame through support shafts respectively; the bed frame at a bottom of the leg board is provided with a leg board screw rod and a backboard screw rod; the leg board screw rod and the backboard screw rod are respectively sleeved with screw sleeves; the screw sleeves are hinged with a connecting plate at the bottom of the leg board and a connecting plate at a bottom of the backboard; the bed frame and the bedside frame adopt a detachable connecting structure; and the leg board screw rod, the backboard screw rod, and the screw sleeves on the leg board screw rod and the backboard screw rod are all detachably connected with the bed frame and the connecting plates.

The bed frame in the prior art is foldable, but its width cannot be adjusted to adapt to mattresses of different sizes.

### SUMMARY

For the shortcomings in the prior art, the present disclosure aims to provide an intelligent movable and retractable bed frame, which can be adjusted in width to adapt to mattresses of different sizes.

The above technical objective of the present disclosure is achieved by the following technical solution: An intelligent movable and retractable bed frame includes an upper bed frame and a bottom bed frame; the upper bed frame is hinged with the bottom bed frame; the upper bed frame includes an upper frame rod and an upper frame crossarm with one end connected to the upper frame rod; the upper frame crossarm is connected with an upper frame extending stand which can transversely move along the upper frame crossarm; the bottom bed frame includes a bottom frame rod and a bottom frame crossarm with one end connected to the bottom frame rod; the bottom frame crossarm is connected with a bottom frame extending stand which can transversely move along the bottom frame crossarm; and the upper frame extending stand is hinged with the bottom frame extending stand.

In a further setting, the bottom frame extending stand includes a bottom frame extending rod, and a bottom frame extending sliding rod I and a bottom frame extending sliding rod I which are respectively fixed on the bottom frame extending rod; and the bottom frame extending sliding rod I and the bottom frame extending sliding rod I are spaced apart and transversely move along the bottom frame crossarm.

In a further setting, the upper frame extending stand includes an upper frame extending rod, and an upper frame extending sliding rod I and an upper frame extending sliding rod I which are respectively fixed on the upper frame extending rod; and the upper frame extending sliding rod I and the upper frame extending sliding rod I are spaced apart and transversely move along the upper frame crossarm.

In a further setting, a linear actuating device for unfolding or folding the upper bed frame and the bottom bed frame is mounted between the upper bed frame and the bottom bed frame.

In a further setting, the linear actuating device includes a linear actuator with one end fixed to the bottom bed frame and the other end hinged to the upper bed frame, and a support arm with one end hinged to the upper bed frame; the other end of the support arm is provided with a guide wheel; the guide wheel resists against the bottom bed frame; and the linear actuator drives the upper bed frame to rise up by means of the guide wheel.

In a further setting, the intelligent movable and retractable bed frame further includes a wireless control box for controlling the linear actuator to work through a signal.

In a further setting, the upper frame extending sliding rod I is provided with several width stop holes; and indicator pins plugged into the width stop holes to limit a stretching width of the bed frame are mounted on the upper frame crossarm.

In a further setting, the bottom bed frame is provided with a fixing member.

In a further setting, the upper bed frame is provided with a mattress limiting stop rod.

To sum up, the present disclosure has the following beneficial effects: The device has a simple structure, is convenient to use and carry, and is adjustable in width to adapt to mattresses of different sizes.

### BRIEF DESCRIPTION OF THE DRAWINGS

FIG. 1 is an overall schematic structural diagram of this embodiment; and

FIG. 2 is a three-dimensional schematic structural diagram of this embodiment.

In the drawings: 1: upper bed frame; 11: upper frame rod; 12: upper frame cross rod I; 13: upper frame cross rod II; 14: upper frame cross rod III; 15: upper frame cross rod IV; 2: upper frame extending stand; 21: upper frame extending rod; 22: upper frame extending sliding rod I; 23: upper frame extending sliding rod II; 3: bottom bed frame; 31: bottom frame crossarm; 32: bottom frame cross rod I; 33: bottom frame cross rod II; 34: bottom frame cross rod III; 4: bottom frame extending stand; 41: bottom frame extending rod; 42: bottom frame extending sliding rod I; 43: bottom frame extending sliding rod II; 5: rotating pin; 6: pipe sleeve; 7: linear actuating device; 71: linear actuator;

72: support arm; 73: guide wheel; 74: hinge arm; 75: shaft sleeve; 8: connecting seat; 9: fixing member; 10: mattress limiting stop rod; and 16: indicator pin.

### DETAILED DESCRIPTION OF THE EMBODIMENTS

The present disclosure is further described in detail below in combination with accompanying drawings.

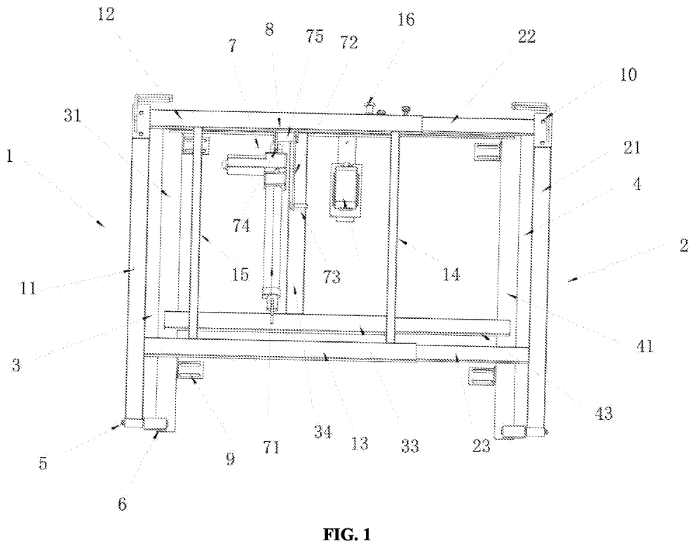

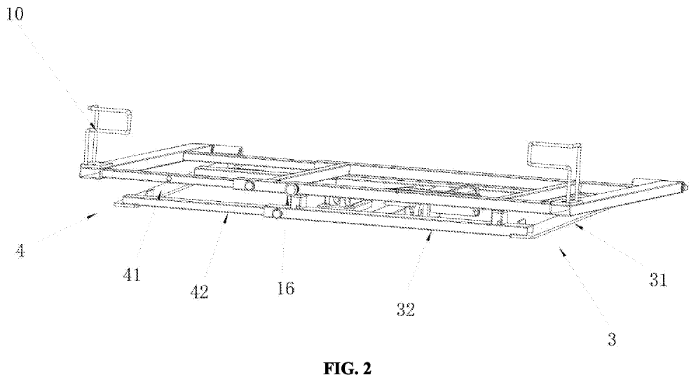

As shown in FIG. 1 to FIG. 2, an intelligent movable and retractable bed frame includes an upper bed frame 1, an upper frame extending stand 2, a bottom bed frame 3, a bottom frame extending stand 4, and a linear actuating device 7. The upper bed frame 1 includes an upper frame rod 11 and an upper frame crossarm with one end connected to the upper frame rod 11. The upper frame crossarm is composed of four rods: an upper frame cross rod I 12, an upper frame cross rod II 13, an upper frame cross rod III 14 and an upper frame cross rod IV 15. The upper frame cross rod I 12 and the upper frame cross rod II 13 are spaced apart, and have one end fixed to the upper frame rod 11. The upper frame cross rod III 14 and the upper frame cross rod IV 15 are spaced apart and are fixed between the upper frame cross rod I 12 and the upper frame cross rod II 13. Sliding chutes are respectively formed in the upper frame cross rod I 12 and the upper frame cross rod II 13

The upper frame extending stand 2 includes an upper frame extending rod 21, and an upper frame extending sliding rod I 22 and an upper frame extending sliding rod II 23 respectively fixed on the upper frame extending rod 21. The upper frame extending sliding rod I 22 is sleeved in the upper frame cross rod I 12, and can move along the sliding chute in the upper frame cross rod I 12. The upper frame extending sliding rod II 23 is sleeved in the upper frame cross rod II 13, and can move along the sliding chute in the upper frame cross rod II 13.

The bottom bed frame 3 includes a bottom frame rod and a bottom frame crossarm 31 with one end connected to the bottom frame rod. The bottom frame crossarm 31 is “I”-shaped and is composed of three rods: a bottom frame cross rod I 32, a bottom frame cross rod II 33 and a bottom frame cross rod III 34. The bottom frame cross rod I 32 and the bottom frame cross rod II 33 are spaced apart, and have one end fixed on the bottom frame rod. The bottom frame cross rod III 34 is fixed between the bottom frame cross rod I 32 and the bottom frame cross rod II 33. Sliding chutes are respectively formed in the bottom frame cross rod I 32 and the bottom frame cross rod II 33.

The bottom frame extending stand 4 includes a bottom frame extending rod 41, and a bottom frame extending sliding rod I 42 and a bottom frame extending sliding rod II 43 respectively fixed on the bottom frame extending rod 41. The bottom frame extending sliding rod I 42 is sleeved in the sliding chute of the bottom frame cross rod I 32 and can move along the sliding chute. The bottom frame extending sliding rod II 43 is sleeved in the sliding chute of the bottom frame cross rod II 33 and can move along the sliding chute.

Rotating pins 5 are respectively arranged at end portions of the upper frame rod 11 and the upper frame extending rod 21. Pipe sleeves 6 are respectively arranged at end portions of the bottom frame rod and the bottom frame extending rod 41. The rotating pins 5 and the pipe sleeves 6 are connected with each other and are respectively hinged with the upper frame rod 11 and the bottom frame rod. The upper frame extending rod 21 is hinged with the bottom frame extending rod 41.

The linear actuating device 7 is mounted between the upper bed frame 1 and the bottom bed frame 3, and can unfold or fold the upper bed frame 1 and the bottom bed frame 3. The linear actuating device 7 includes a linear actuator 71 and a support arm 72 with one end hinged to the upper bed frame 1. The other end of the support arm 72 is provided with a guide wheel 73. The guide wheel 73 resists against the bottom frame cross rod III 34. The upper frame cross rod I 12 is provided with a connecting seat 8. The connecting seat 8 is provided with a pin shaft. The pin shaft is hinged with a hinge arm 74, a shaft sleeve 75 and the support arm 72. One end of the linear actuator 71 is connected with the upper frame cross rod I 12 through the hinge arm 74, and the other end is fixed to the bottom bed frame 3. The linear actuator 71 drives the upper bed frame 1 to rise up by means of the guide wheel 73.

This bed frame is adjustable in width, and is provided with a limiting structure for maximum and minimum stretching dimensions. In the limiting structure, the upper frame extending sliding rod I 22 is provided with several width stop holes; and indicator pins 16 plugged into the width stop holes to limit a stretching width of the bed frame are mounted on the upper frame crossarm. After the width is adjusted, the width is locked by handle screws of the upper frame cross rod I 12 and the bottom frame cross rod I 32.

This product can be wirelessly remotely controlled. The bottom frame cross rod I 32 is provided with a wireless control box which controls the linear actuator 71 to work through a signal.

The bottom bed frame 3 is provided with a fixing member 9. The fixing member 9 is a sliding chute strap iron. The upper bed frame 1 is provided with a mattress limiting stop rod 10. The mattress limiting stop rod 10 cooperates with the sliding chute strap iron to fix the whole bed frame on a bed surface.

The specific embodiment is only an explanation of the present disclosure, and it is not a limitation to the present disclosure. After reading this specification, those skilled in the art can make modifications to this embodiment that do not create any contribution as needed, but the modifications shall be protected by the patent law within the scope of the claims of the present disclosure.

What is claimed is:

1. An intelligent movable and retractable bed frame, comprising an upper bed frame and a bottom bed frame, wherein the upper bed frame is hinged with the bottom bed frame; the upper bed frame comprises an upper frame rod and an upper frame crossarm with one end connected to the upper frame rod; the upper frame crossarm is connected with an upper frame extending stand which can transversely move along the upper frame crossarm; the bottom bed frame comprises a bottom frame rod and a bottom frame crossarm with one end connected to the bottom frame rod; the bottom frame crossarm is connected with a bottom frame extending stand which can transversely move along the bottom frame crossarm; and the upper frame extending stand is hinged with the bottom frame extending stand.

2. The intelligent movable and retractable bed frame according to claim 1, wherein the bottom frame extending stand comprises a bottom frame extending rod, and a bottom frame extending sliding rod I and a bottom frame extending sliding rod I which are respectively fixed on the bottom frame extending rod; and the bottom frame extending sliding rod I and the bottom frame extending sliding rod I are spaced apart and transversely move along the bottom frame crossarm.

3. The intelligent movable and retractable bed frame according to claim 1, wherein the upper frame extending stand comprises an upper frame extending rod, and an upper frame extending sliding rod I and an upper frame extending sliding rod I which are respectively fixed on the upper frame extending rod; and the upper frame extending sliding rod I and the upper frame extending sliding rod I are spaced apart and transversely move along the upper frame crossarm.

4. The intelligent movable and retractable bed frame according to claim 1, wherein a linear actuating device for unfolding or folding the upper bed frame and the bottom bed frame is mounted between the upper bed frame and the bottom bed frame.

5. The intelligent movable and retractable bed frame according to claim 4, wherein the linear actuating device comprises a linear actuator with one end fixed to the bottom bed frame and the other end hinged to the upper bed frame, and a support arm with one end hinged to the upper bed frame; the other end of the support arm is provided with a guide wheel; the guide wheel resists against the bottom bed frame; and the linear actuator drives the upper bed frame to rise up by means of the guide wheel.

6. The intelligent movable and retractable bed frame according to claim 5, further comprising a wireless control box for controlling the linear actuator to work through a signal.

7. The intelligent movable and retractable bed frame according to claim 3, wherein the upper frame extending sliding rod I is provided with several width stop holes; and indicator pins plugged into the width stop holes to limit a stretching width of the bed frame are mounted on the upper frame crossarm.

8. The intelligent movable and retractable bed frame according to claim 1, wherein the bottom bed frame is provided with a fixing member.

9. The intelligent movable and retractable bed frame according to claim 1, wherein the upper bed frame is provided with a mattress limiting stop rod.
